(19) United States
(12) Patent Application Publication
(10) Pub. No.: US 2019/0047341 A1
(43) Pub. Date: Feb. 14, 2019

(54) COUPLING

(71) Applicant: TRU-TURF PTY LTD, Arundel, Queensland (AU)

(72) Inventor: Raymond Jeffrey DUFTY, Arundel (AU)

(21) Appl. No.: 16/077,118

(22) PCT Filed: Feb. 10, 2017
(86) PCT No.: PCT/AU2017/050105

§ 371 Date: Aug. 10, 2018

(30) Foreign Application Priority Data
Feb. 10, 2016 (AU) 2016900437

(51) Int. Cl. B60D 1/02; B60D 1/28

(52) U.S. Cl. CPC B60D 1/02; B60D 1/28

(57) ABSTRACT

A coupling for a drawbar including a body having a connecting member extending therefrom; and a retaining member connected to the body, wherein the retaining member is configured to move from a first position to a second position, the second position increasing a projection adjacent to the connecting member such that movement from an end of the connecting member is restricted.

### FIELD OF THE INVENTION

The invention relates to a coupling. In particular, the invention relates, but is not limited, to a coupling for a drawbar.

### BACKGROUND TO THE INVENTION

Reference to background art herein is not to be construed as an admission that such art constitutes common general knowledge in Australia or elsewhere.

A drawbar is associated with a coupling between a vehicle and its hauled load. Drawbars are in common use with, for example, recreational machinery and agricultural equipment.

A relatively common drawbar design includes a clevis-type coupling. A clevis-type coupling comprises a U-shaped or forked metal with aligned holes therethrough. This clevis-type coupling may be connected to a tow hitch via inserting a bolt or pin through a hole in the tow hitch that is aligned with the holes in the clevis-type coupling.

However, a problem associated with a clevis-type coupling is that it is difficult to align holes in the coupling with the hole in the tow hitch in order to insert the separate pin therethrough. This problem is further compounded when the tow hitch is set back from the outer portion of the vehicle, making access to the tow hitch difficult.

### OBJECT OF THE INVENTION

It is an aim of this invention to provide a coupling which overcomes or ameliorates one or more of the disadvantages or problems described above, or which at least provides a useful alternative.

Other preferred objects of the present invention will become apparent from the following description.

### SUMMARY OF INVENTION

In one form, although not necessarily the only or broadest form, the invention resides in a coupling for a drawbar including:

a body having a connecting member extending therefrom; and

a retaining member connected to the body, wherein the retaining member is configured to move from a first position to a second position, the second position increasing a projection adjacent to the connecting member such that movement from an end of the connecting member is restricted.

Preferably, the body includes a base member and a support member.

Preferably, the support member extends outwardly from the base member.

Preferably, the support member extends outwardly from the base member in a longitudinal direction along the base member.

Preferably, the connecting member extends from the support member.

Preferably, the connecting member extends in a substantially downward direction from the support member.

Preferably, the connecting member extends substantially perpendicular to the base member and/or support member.

Preferably, the retaining member is pivotally and/or slidably connected to the body.

Preferably, the retaining member is pivotally and/or slidably connected to the base member.

Preferably, the retaining member includes a retention portion and an actuation portion.

Preferably, the retention portion includes a connector portion. Preferably, the retention portion includes a tab portion.

Preferably, the connector portion is pivotally connected to the body.

Preferably, the connector portion includes two side portions having an aperture therethrough.

Preferably, the side portions are connected together by a central portion.

Preferably, the tab portion is connected at an end of the connector portion.

Preferably, the tab portion is connected at a lower end of the side portions.

Preferably, the tab portion includes a receiving aperture.

Preferably, the receiving aperture is configured to receive the connecting member.

Preferably, the actuation portion includes an extension portion and a handle portion.

Preferably, the extension portion extends from an end of the connector portion.

Preferably, the extension portion includes a first portion and a second portion.

Preferably, the second portion extends upwardly from the first portion.

Preferably, the handle is located adjacent to the second portion.

Preferably, the base member includes a locking member.

Preferably, the locking member is configured to releasably capture the retaining member.

Preferably, the locking member is configured to releasably capture the actuation portion.

Preferably, in the first position, the retaining member is located a distance away from the retaining member.

Preferably, in the first position, the retaining member is located a distance below the retaining member.

Preferably, in the first position, the retaining member substantially allows movement over and/or from the end of the connecting member.

Preferably, in first position, the actuation portion is unlocked from the locking member.

Preferably, from the first position to the second position, the retaining member rotates towards the connecting member.

Preferably, from the first position to the second position, the actuation portion moves in a downward direction.

Preferably, the retaining member rotates anti-clockwise from the first position to the second position.

Preferably, from the first position to the second position, the actuation portion moves towards the locking member.

Preferably, in the second position, the connecting member extends into the aperture of the tab portion.

Preferably, in the second position, the tab portion is substantially aligned with the end of the connecting member.

Preferably, in the second position, the actuation portion is releasable captured in the locking member.

In another form, the invention resides in a coupling for a drawbar including:

a body having a connecting member extending therefrom; and

a retaining member connected to the body, the retaining member having a tab portion with a receiving aperture, wherein the retaining member is configured to move from a first position to a second position, the second position locating the receiving aperture adjacent to the retaining member such that movement from an end of the connecting member is restricted by the tab portion.

Preferably, the coupling is herein as described.

In another form, the invention resides in a coupling for a drawbar including:

a body having a connecting member extending therefrom; and

a retaining member, wherein the retaining member is configured to move from a first position to a second position, the second position increasing a projection adjacent to the connecting member such that movement from an end of the connecting member is restricted.

Preferably, the coupling is herein as described.

In another form the invention resides in a method for providing a coupling, the method including the steps of:

locating a connecting member through a tow coupling; and

moving a retaining member from a first position to a second position, the second position restricting movement from an end of the connecting member.

Preferably, the step of moving the retaining member from the first position to the second position includes moving an aperture of the retaining member such that the connecting member extends therein.

Preferably, the step of moving the retaining member from the first position to the second position includes rotating the retaining member from a lower position to an upper position.

Preferably, the step of moving the retaining member from the first position to the second position includes moving a tab portion of the retaining member to be adjacent to the connecting portion.

Preferably, the step of moving the tab portion of the retaining member to be adjacent to the connecting portion includes substantially aligning the tab portion with the end of the connecting member.

Preferably, the step of moving the retaining member from the first position to the second position includes capturing the retaining member in a locking member.

Preferably, the step of capturing the retaining member in the locking member includes moving the retaining member into a cavity of the locking member.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates an exploded view of a coupling, according to an embodiment of the invention;

FIG. 2 illustrates a perspective view of the coupling, as shown in FIG. 1, in a first configuration;

FIG. 3 illustrates a perspective view of the coupling, as shown in FIG. 1, in a second configuration; and

FIG. 4 illustrates a perspective view of the coupling shown in FIG. 1 with the addition of a fastening member.

### DETAILED DESCRIPTION OF THE DRAWINGS

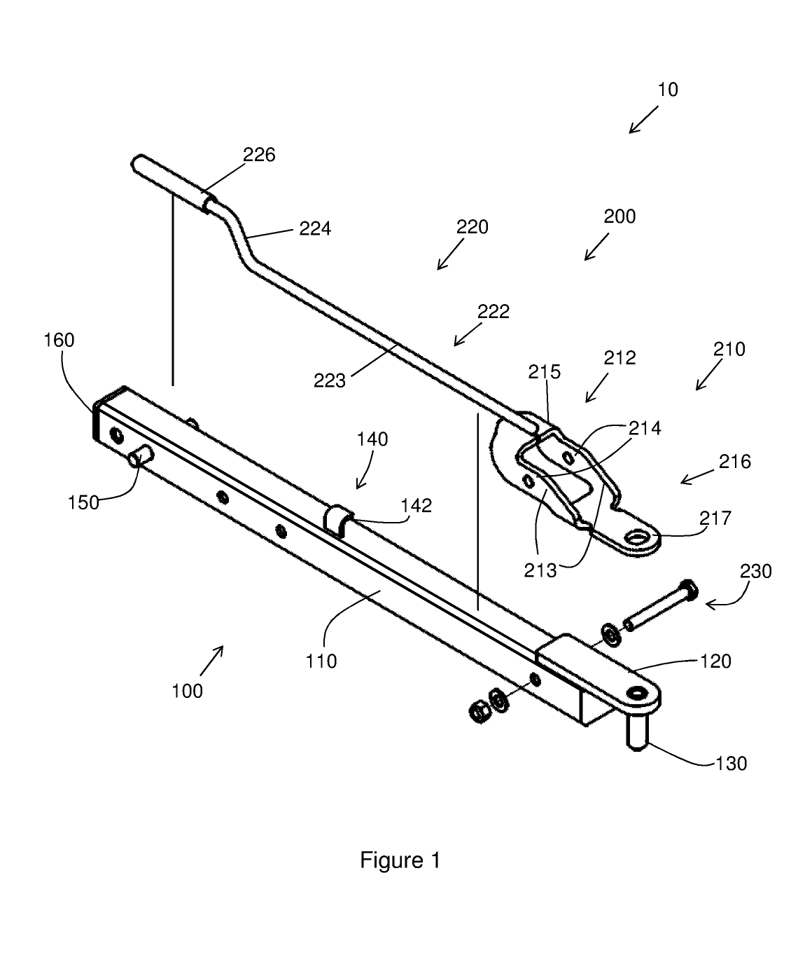

FIG. 1 illustrates an exploded view of the coupling 10, according to an embodiment of the invention. The coupling 10 includes a body 100 and a retaining member 200.

The body 100 includes a base member 110, a support member 120 and a connecting member 130. The base member 110, in this embodiment, is in the form of a hollow elongate member. In particular, the base member 110 is in the form of rolled hollow steel. The base member 110 is substantially straight.

The support member 120 extends from the base member 110 in a direction that is in line with a longitudinal axis of the base member 110. The support member 120 is connected to an upper face of the base member 110 such that a space is left between an end portion of the base member 110 and an end portion of the support member 120.

The connecting member 130 is attached to the support member 120. The connecting member 130 extends in a downward direction from the support member 120 into the space left between the end portion of the base member 110 and the end portion of the support member 120. The connecting member 130 is in the form of an elongate cylindrical member (i.e. a pin) in this embodiment.

The body 100 also includes a locking member 140. The locking member 140 is connected along the base member 110. The locking member 140 extends upwardly from the upper face of the base member 110. The locking member 140 includes a curved portion that defines a cavity 142. The cavity 142 is substantially semi-circular in form.

The base member 110 includes a plurality of apertures along the side faces thereof. The plurality of apertures are symmetrically located along the side faces of the base member 110. In this regard, two apertures are typically aligned either side of the base member 110. These aligned apertures are configured to receive a pin 150 therethrough. The pin 150 acts as a lock down pin for attachment to a trailer. The base member 110 also includes a cap 160. The cap 160 is located at an end portion of the base member 110, which is opposite to where the support member 120 is connected.

The retaining member 200 includes a retention portion 210 and an actuation portion 220. The retention portion 210 includes a connector portion 212 and a tab portion 216. The connector portion 212 has two side portions 213 with aligned apertures 214. The side portions 213 are connected together by a central portion 215. The side portions 213 are also connected together by the tab portion 216. The tab portion 216 is located at a lower level compared to the central portion 215. The tab portion 216 includes a receiving aperture 217. As further outlined below, the receiving aperture 217 is configured to receive the connecting member 130.

The connector portion 212 is pivotally connected to the base member 110 via the apertures 214 in the side portions 213. In particular, a fastener 230 releasably connects the connector portion 212 to the base member 110, via the apertures 214, such that the retaining member 200 may rotate thereabout. It would be appreciated in further embodiments that the connector portion 212 may, for example, be slidably connected to the base member 110.

The actuation portion 220 includes an extension portion 222 and a handle portion 226. The extension portion 222 includes a first portion 223 and a second portion 224. The first portion 223 is a substantially straight bar. The second portion 224 extends in a transverse direction away from the first portion 223. The handle portion 226 is located at an end of the second portion 224.

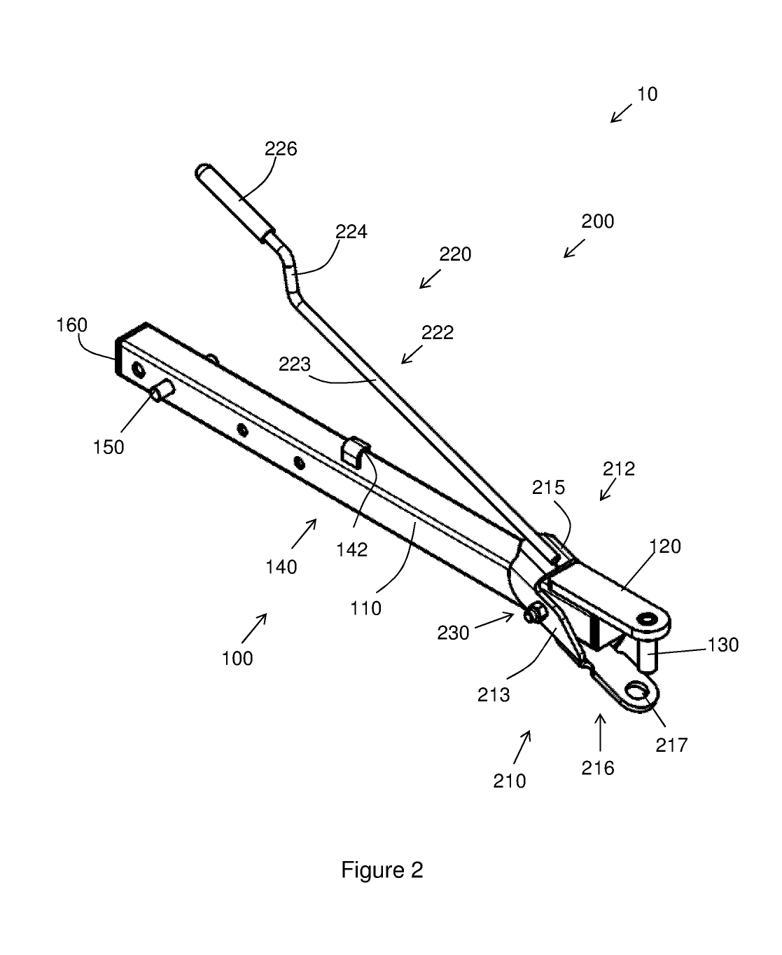

FIG. 2 illustrates a perspective view of the coupling 10, in a first configuration, according to an embodiment of the invention. In particular, the retaining member 200 is shown in a first position. In this first position, the actuation portion 220 extends in an upward direction in order for the tab portion 216 to extend in a downward direction. As the tab portion 216 extends in a downward direction, the tab portion 216 is located a distance away from the connecting member 130. This allows for objects to move over the connecting member 130 at an end thereof. In this case, whilst the retaining member 200 is in the first position, the connecting member 130 may be located through an aperture in a tow coupling (not shown).

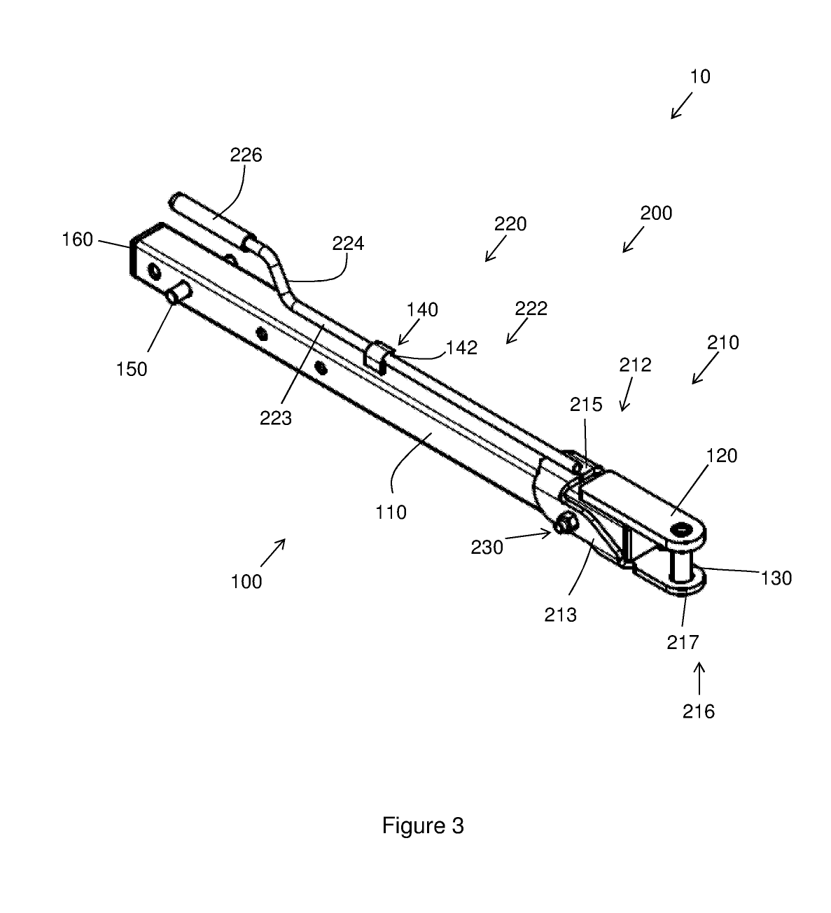

After locating the connecting member 130 through the aperture in the tow coupling (i.e. a tow hitch), the retaining member 200 is moved to a second position. This is shown further in FIG. 3 where the coupling 10 is in a second configuration, according to an embodiment of the invention.

As would be appreciated, to move the retaining member 200 from the first position to the second position, the actuation portion 220 is moved (i.e. pivoted or rotated) towards the base member 110. As the actuation portion 220 moves towards the base member 110, the tab portion 216 moves towards the connecting member 130. In the second position, the connecting member 130 is received into the receiving aperture 217. Accordingly, the tab portion 216 increases a projection adjacent to the connecting member 130 such that movement from the end of the connecting member 130 is restricted. In this regard, movement of the tow coupling from the connecting member 130 is restricted when the retaining member 200 is adjacent thereto.

To ensure that the retaining member 200 remains substantially adjacent to the connecting member 130, and therefore assists in retaining the tow coupling on the connecting member 130, the first portion 223 of the extension portion 222 is secured by the locking member 140. That is, the first portion 223 is maneuvered under a portion of the locking member 140 and then positioned up in the cavity 142. In this regard, in response to the tow coupling applying a force onto the tab portion 216, the locking member 140 assists in preventing the retaining member 200 from moving (i.e. pivoting or rotating) and, therefore, the tow coupling is retained on the connecting member 130. With this in mind, it would be appreciated that to release the tow coupling, the method above is undertaken substantially in reverse.

With the connecting member 130 (i.e. pin) fixed to the support member 120, placing the connecting member 130 through the tow coupling (i.e. tow hitch) is made relatively simple in comparison to aligning holes in a drawbar, with the tow hitch, in order to insert a separate pin therethrough. This advantage assists in the ergonomics associated with attaching a trailer to a tow coupling of a vehicle. This advantage is also further appreciated when the tow hitch is set back from the outer portion of a vehicle, making access to the tow hitch difficult.

In addition, the retaining member 200 readily assists in retaining a tow coupling on the connecting member 130. That is, whilst the actuation portion 220 is captured in the locking member 140, the tab portion 216 of the retention portion 210 substantially restricts movement from the end of the connecting member 130. That being said, when connecting member 130 is required to be released from the tow coupling, the actuation portion 220 may be moved, relatively easily, in order to allow the locking member 130 to be released from the tow coupling.

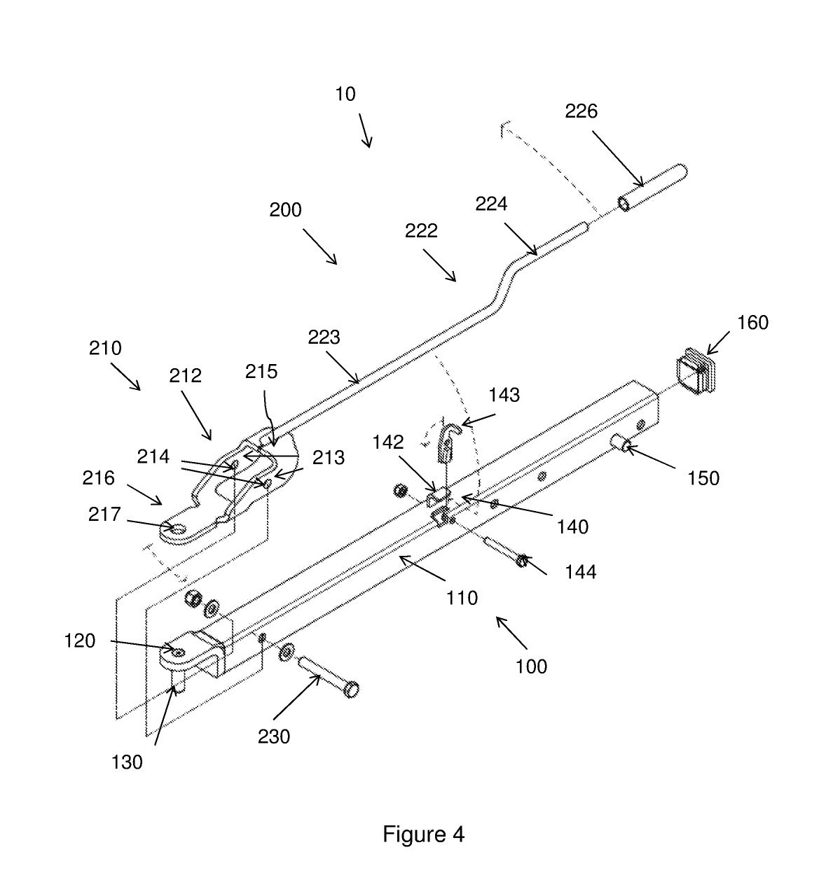

FIG. 4 shows a second embodiment of the coupling 10. Like numerals have been used to described like components. The coupling includes pivotal fastening member 143 which is attached to the body 100 via a fastener 144. The pivotal fastening member 143 is located adjacent the locking member 140. The pivotal fastening member 143 is able to pivot between a catch position in which the first portion 223 is held fast by the fastening member and a release position in which the first portion 223 can move. The fastening member 143 ensures that the first portion 223 cannot be accidently removed from the locking member 140.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. (canceled)

2. (canceled)

3. A coupling for a drawbar including:
a body having a connecting member extending therefrom; and
a retaining member,
wherein the retaining member is configured to move from a first position to a second position, the second position increasing a projection adjacent to the connecting member such that movement from an end of the connecting member is restricted.

4. The coupling of claim 3, wherein the body includes a base member and a support member.

5. (canceled)

6. The coupling of claim 4, wherein the support member extends outwardly from the base member in a longitudinal direction along the base member.

7. (canceled)

8. The coupling of claim 4, wherein the connecting member extends in a substantially downward direction from the support member.

9. (canceled)

10. The coupling of claim 3, wherein the retaining member is pivotally and/or slidably connected to the body.

11. (canceled)

12. The coupling of claim 3, wherein the retaining member includes a retention portion and an actuation portion.

13. The coupling of claim 12, wherein the retention portion includes a connector portion.

14. The coupling of claim 12, wherein the retention portion includes a tab portion.

15. The coupling of claim 13, wherein the connector portion is pivotally connected to the body.

16. The coupling of claim 13, wherein the connector portion includes two side portions having an aperture therethrough.

17. The coupling of claim 16, wherein the side portions are connected together by a central portion.

18. The coupling of claim 14, wherein the tab portion is connected at an end of the connector portion.

19. (canceled)

20. The coupling of claim 14, wherein the tab portion includes a receiving aperture.

21. The coupling of claim 20, wherein the receiving aperture is configured to receive the connecting member.

22. The coupling of claim 12, wherein the actuation portion includes an extension portion and a handle portion.

23. (canceled)

24. The coupling of claim 22, wherein, the extension portion includes a first portion and a second portion.

25. The coupling of claim 24, wherein, the second portion extends upwardly from the first portion.

26. The coupling of claim 22, wherein, the handle is located adjacent to the second portion.

27. The coupling of claim 4, wherein, the base member includes a locking member.

28. The coupling of claim 27, wherein, the locking member is configured to releasably capture the retaining member.

29. (canceled)

30. The coupling of claim 3, wherein, in the first position, the retaining member is located a distance away from the retaining member.

31. (canceled)

32. The coupling of claim 3, wherein, in the first position, the retaining member substantially allows movement over and/or from the end of the connecting member.

33. (canceled)

34. The coupling of claim 3, wherein, from the first position to the second position, the retaining member rotates towards the connecting member.

35. (canceled)

36. (canceled)

37. The coupling of claim 27, wherein, from the first position to the second position, the actuation portion moves towards the locking member.

38. The coupling of claim 20, wherein, in the second position, the connecting member extends into the aperture of the tab portion.

39. The coupling of claim 14, wherein, in the second position, the tab portion is substantially aligned with the end of the connecting member.

40. The coupling of claim 3, wherein, in the second position, the actuation portion is releasable captured in the locking member.

41. (canceled)

42. (canceled)

43. (canceled)

44. (canceled)

45. (canceled)

46. (canceled)

47. (canceled)
